(19) United States
(12) Patent Application Publication
(10) Pub. No.: US 2024/0323703 A1
(43) Pub. Date: Sep. 26, 2024

(54) LOW LATENCY MULTI-LINK DEVICE (MLD) PHY/MAC RELAY (LLMR)

(71) Applicant: MaxLinear, Inc., Carlsbad, CA (US)

(72) Inventor: Saju Palayur, Carlsbad, CA (US)

(73) Assignee: MaxLinear, Inc., Carlsbad, CA (US)

(21) Appl. No.: 18/613,098

(22) Filed: Mar. 21, 2024

Related U.S. Application Data
(60) Provisional application No. 63/491,396, filed on Mar. 21, 2023.

(51) Int. Cl. H04W 16/26; H04W 74/0816

(52) U.S. Cl. CPC H04W 16/26; H04W 74/0816

(57) ABSTRACT

Technology is disclosed for an access point (AP), comprising a processing device. The processing device may be operable to receive, at the AP from a different AP, a first wireless signal at a first frequency. The processing device may be operable to convert, at the AP, the first wireless signal at the first frequency to a second wireless signal at a second frequency, wherein the second frequency is higher than the first frequency. The processing device may be operable to send, from the AP for transmission to a station (STA), the second wireless signal at the second frequency.

### RELATED APPLICATION

This application claims the benefit of U.S. Provisional Application No. 63/491,396, filed Mar. 21, 2023, the disclosure of which is incorporated herein by reference in its entirety.

### FIELD

This disclosure relates to wireless communication, and more specifically, to Multi-Link Device (MLD) Operation and more specifically, to low latency multi-link device (MLD) PHY/MAC relay (LLMR).

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi. Wi-Fi communications can be configured to occur in multiple frequency bands, including 2.4 GHz, 5 GHz, and 6 GHz bands.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

An access point (AP) may include a processing device operable to: receive, at the AP from a different AP, a first wireless signal at a first frequency. The processing device may be operable to convert, at the AP, the first wireless signal at the first frequency to a second wireless signal at a second frequency. The second frequency may be higher than the first frequency. The processing device may be operable to send, from the AP for transmission to a station (STA), the second wireless signal at the second frequency.

A method for wireless local area network (WLAN) medium access control (MAC) relay may include selecting, at an access point, a relay client based on one or more of a signal strength or a network congestion. The method may include forwarding, from the access point for transmission to a station (STA) using the relay client, a frame, wherein the access point is not within a direct communication range of the STA.

A relay client may include a processing device operable to receive, at a relay client from an AP, a first wireless signal at a first frequency. The relay client may be operable to convert, at the relay client, the first wireless signal at the first frequency to a second wireless signal at a second frequency. The second frequency may be higher than the first frequency. The relay client may be operable to send, from the relay client for transmission to a station (STA), the second wireless signal at the second frequency.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example diagram of Wi-Fi packets transmitted on multiple links concurrently.

FIG. 1B illustrates an example diagram of Wi-Fi packets transmitted on multiple links concurrently.

FIG. 2 illustrates an example coverage diagram for a first station (STA), a first access point (AP), a second access point (AP), and a second STA.

FIG. 3 illustrates an example coverage diagram for a first station (STA), a first access point (AP), a second access point (AP), and a second STA.

FIG. 4A illustrates an example coverage diagram for a first station (STA), a first access point (AP), a second access point (AP), and a second STA.

FIG. 4B illustrates an example coverage diagram for a first station (STA), a first access point (AP), a relay client, and a second STA.

FIG. 5A illustrates an example diagram of Wi-Fi packets transmitted among a STA, a first AP, and a second AP.

FIG. 5B illustrates an example diagram of Wi-Fi packets transmitted among a STA, a relay client, and a first AP.

FIG. 6A illustrates an example diagram of Wi-Fi packets transmitted among a STA, a first AP, and a second AP.

FIG. 6B illustrates an example diagram of Wi-Fi packets transmitted among a STA, a relay client, and a first AP.

FIG. 7 illustrates a block diagram of an example communication system operable to for low latency multi-link device (MLD) PHY relay (LLMR).

FIG. 8 illustrates a process flow of an access point operable for LLMR.

FIG. 9 illustrates a process flow for a method for LLMR.

FIG. 10 illustrates a diagrammatic representation of a machine in the example form of a computing device within which a set of instructions, for causing the machine to perform any one or more of the methods discussed herein, may be executed.

### DESCRIPTION OF EMBODIMENTS

The present disclosure provides techniques to increase the range of one (or more) of the links of a Wi-Fi multi-link device (MLD) with latencies at or close to zero. The techniques provide significant advantages, including in view of existing mesh networking.

In some embodiments, a relay is used for MLD operation, and the relay may be used for fewer than all of the links. The disclosed relay may include a physical layer (PHY) relay and/or a Wi-Fi Medium Access Control (MAC) relay. The relay may provide techniques to extend the reach and enhance the efficiency of Wi-Fi networks. The PHY relay may extend or enhance certain frequency ranges. The techniques for the MAC relay may involve using intermediate devices to forward frames between an access point and client devices that might not be directly within each other's range. This disclosed systems and methods enable dynamic selection of an optimal relay node, guided by algorithms that assess signal strength and network congestion, to reduce latency and enhance throughput. Further advantages may include providing compatibility with existing Wi-Fi standards for seamless integration. Moreover, for multi-hop systems, an optimal relay path can be chosen based on Quality of Service (QOS) needs. The present disclosure also may enhance performance with strategies considering MAC and PHY layers. Additionally, the present disclosure also implements energy-saving strategies for battery-operated relays.

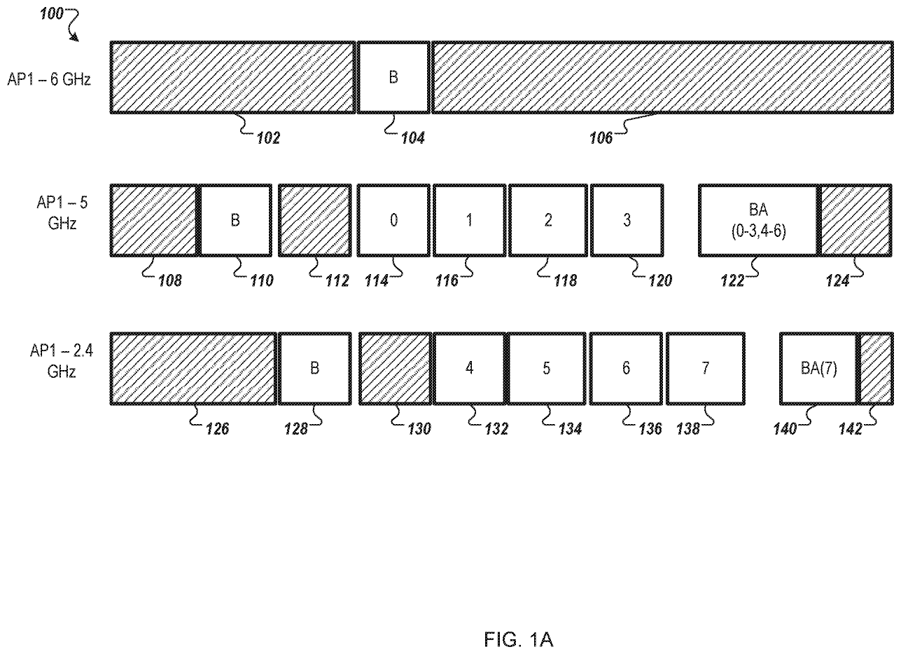

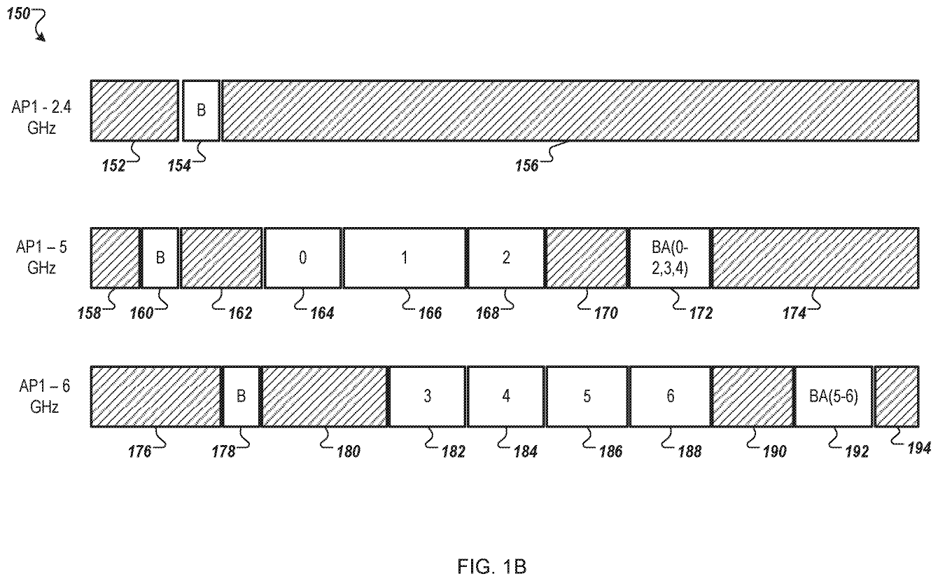

As illustrated in FIG. 1A, a packet diagram 100 shows that in Simultaneous Transmit and Receive (STR) mode, a Wi-Fi device (e.g., an access point (AP1), a station (STA), etc.) may transmit and receive Wi-Fi packets on multiple links concurrently. As illustrated, there are three links depicted in FIG. 1A-AP1-6 GHZ, AP1-5 GHz, and AP1-2.4 GHz. These different links can be part of the same AP. The transmit and receive operations may not be aligned because the multiple links may be far enough apart in frequency and may not interfere with each other. The Wi-Fi device may aggregate traffic from the multiple links, which may increase throughput.

A first access point may be operable in one or more of a 2.4 GHz frequency range (e.g., using a 2.4 GHz link), a 5 GHz frequency range (e.g., using a 5 GHz link), or a 6 GHz frequency range (e.g., using a 6 GHz link). When the access point is operable in a 6 GHz frequency range, in one example, a beacon frame 104 may be transmitted, for example using the 6 GHz link. When the access point is operable in a 5 GHz frequency range, a beacon frame 110 may be transmitted, for example using the 5 GHz link. When the access point is operable in a 2.4 GHz range, a beacon frame 128 may be transmitted, for example using the 2.4 GHz link.

In addition to the beacon frames, the first access point may transmit packet0 114, packet1 116, packet2 118, packet3 120, and block acknowledgment (BA) 122 when the first access point is operable in a 5 GHz frequency range. In addition or alternatively, the first access point may not transmit in various time periods, such as time periods 108, 112, 124.

When the first access point is operable to transmit in a 2.4 GHz frequency range, the first access point may transmit packet4 132, packet5 134, packet6 136, packet7 138, and BA 140. In addition or alternatively, the first access point may not transmit in various time periods, such as time periods 126, 130, and 142.

When the first access point is operable to transmit in a 6 GHz frequency range, the first access point may not transmit in various time periods, such as time periods 102 and 106.

In some embodiments, the BA 122 may be used across links. As illustrated, the BA may be used in conjunction with packets 0-3 (packet0 114, packet1 116, packet2 118, packet3 120) associated with 5 GHz frequency range and with packets 4-6 (packet4 132, packet5 134, packet6 136) associated with 2.4 GHz frequency range. The BA 122 may be communicated over the AP1-5 GHz link even though some of the ACKs are for packets associated with a different link (e.g., the 2.4 GHz link in the illustration). BA 140 may be for packet 7 138 and may be communicated over the 2.4 GHz link.

As illustrated in FIG. 1B, a packet diagram 150 is shown. A first access point (e.g., AP1) may be operable to transmit in a 2.4 GHz frequency range, which may include transmitting a beacon frame 154. The first access point may not transmit in various time periods, such as time periods 152 and 156.

The first access point may be operable to transmit in a 5 GHz frequency range. The first access point may transmit a beacon frame 160, a packet0 164, a packet1 166, a packet2 168, and a BA 172. The first access point may not transmit in various time periods, such as time periods 158, 162, 170, and 174.

The first access point may be operable to transmit in a 6 GHz frequency range. The first access point may transmit a beacon frame 178, a packet3 182, a packet4 184, a packet5 186, a packet6 188, and a BA 192. The first access point may not transmit in various time periods, such as time periods 176, 180, 190, and 194. The BA 172 may be associated with ACKs for packets transmitted over different links, such as for packet0 164, packet1 166, and packet2 168 transmitted over a 5 GHz link and for packet3 182 and packet4 184 transmitted over a 6 GHz link.

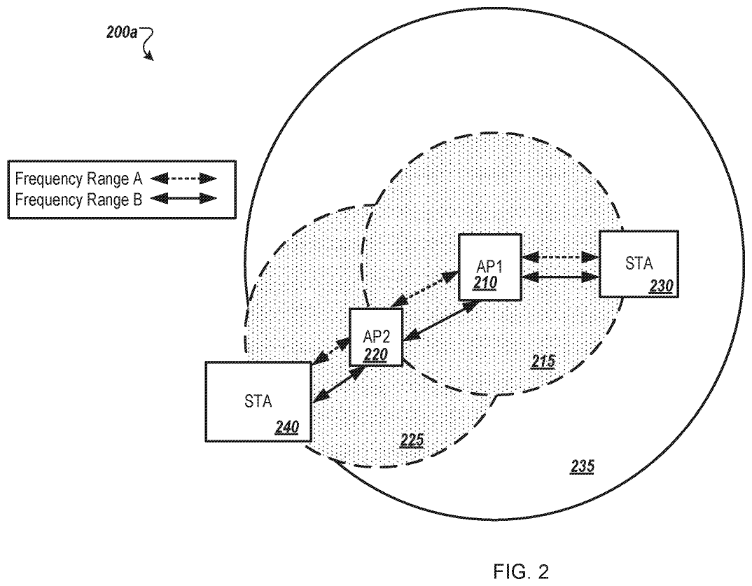

When a multi-link device (MLD) operates on 2.4 GHz and 5 GHz, the 5 GHz transmission or operable range may be much smaller than for 2.4 GHz. To get MLD working using both the bands' mesh, access points (APs) (e.g., first access point 210 and second access point 220 of FIG. 2, or any other AP in any figure of the present disclosure) may be deployed. This may result in increased latency due to the extra network hop (e.g., the extra hop provided by the second access point 220). In cases where a second AP 220, AP2, is also operating in the same band, AP1 210 has to yield to AP2 220, which may be due to an overlapping basic service set (OBSS).

The disclosed Wi-Fi AP/extender may be used to increase the range of the higher-frequency link (e.g., a 5 GHz link) of the MLD, while the other link, which may be operating on the 2.4 GHz frequency range, may be received directly. This immediate relay at the RF or the PHY level or MAC level may reduce latencies at or close to zero. In this manner, range may be increased for links that typically have a shorter range, while maintaining range and latency characteristics of links that typically operate with greater range. More specifically, 2.4 GHz typically operates at a higher range than 5 GHz, while 5 GHz typically can provide higher speeds at a closer range. The present disclosure can build upon these characteristics to provide greater range for 5 GHz links without adding unnecessary hardware for an additional 2.4 GHz link.

As illustrated in FIG. 2, a first access point 210 may have a coverage area 215, a second access point 220 may have a coverage area 225a, a first STA 230 may be operable to communicate with the first access point 210, and a second STA 240 may be operable to communicate with the second access point 220. Alternatively or in addition, the first access point may have a coverage area 235. The coverage area 215 may be a coverage area provided by a 5 GHz frequency range (or any other frequency range). The coverage area 225 may be a coverage area provided by a 5 GHz frequency range, for example. The coverage area 235 may be a coverage area provided by a 2.4 GHz frequency range, for example. In some embodiments, the coverage area 225 may be a coverage area provided by a 6 GHz frequency range, or any other frequency range. In some embodiments, the coverage area 215 may be associated with a same or similar frequency range as coverage area 225. In some embodiments, the coverage area 215 may be associated with a different frequency range than the frequency range for coverage area 225.

In FIG. 2, a coverage map 200a shows that the STA 230 may be operable to communicate an uplink signal to the first access point 210 using a first frequency range A (e.g., 2.4 GHz frequency range) illustrated as a dashed line and a second frequency B (e.g., a 5 GHz frequency range) illustrated as a solid line, as the STA 230 may have links capable of operating within these frequency ranges. The first access point 210 may be operable to communicate a signal to the second access point 220 using one or more frequency ranges (e.g., the first frequency range A, the second frequency range B). The second access point may be operable to communicate a signal to the STA 240 using one or more frequency ranges (e.g., the first frequency range A, the second frequency range B).

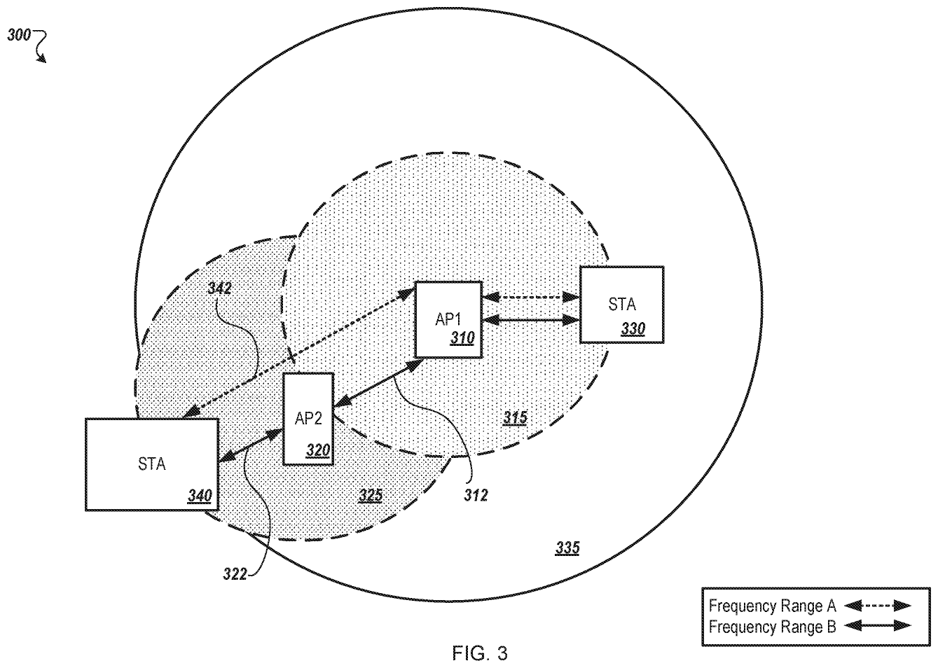

As illustrated in FIG. 3, a coverage map 300 shows a first AP 310 and a second AP 320. The first AP 310 may include multiple wireless links that can operate at different frequency ranges (e.g., 2.4 GHz, 5 GHZ, 6 GHZ, etc.). The AP1 may establish multi-link communication with a STA 340. In doing so the AP1 310 may determine a distance between the AP1 310 and the STA 340. In the event that the range is suitable for a certain frequency range (e.g., 2.4 GHz), but too distant for a different frequency range (e.g., 5 GHZ), the AP1 310 may identify another access point, AP2 320, that can function as a PHY and/or MAC relay for the multi-link communication for the different frequency range. For example, the AP1 310 can establish direct communication 342 with the STA in the 2.4 GHz frequency range. For communication in the 5 GHz frequency range, the AP1 310 can establish communication 312 with the AP2 320, and the AP2 320 can establish a communication 322 with the STA 340. In some embodiments, the communication 312 and communication 322 are in the same frequency range (e.g., both 5 GHz). In some embodiments, the communication 312 and communication 322 are in differing frequency range (e.g., communication 312 is 5 GHz and communication 322 is 6 GHz).

In an embodiment, the second AP 320 may include a processing device. The processing device may be operable to receive, at the second AP 320 from a different AP (e.g., first AP 310), a first wireless signal at a first frequency (e.g., 5 GHZ). The processing device may be operable to convert, at the second AP 320, the first wireless signal at the first frequency to a second wireless signal at a second frequency (e.g., 6 GHZ). The second frequency may be higher than the first frequency. The processing device may be operable to send, from the AP for transmission to a station (STA), the second wireless signal at the second frequency. The first frequency may be in a 5 GHz frequency range and the second frequency may be in a 6 GHz frequency range. The different AP (e.g., first access point 310) may not be in a direction communication range of a STA 340 (e.g., when communicating using a 5 GHz frequency range of a 6 GHz frequency range).

Referring to FIG. 3, a 2.4 GHz 312 communication may be directly received by the STA (e.g., a Laptop). Because Wi-Fi is half-duplex, a different band may be used for the relay. A 5 GHz communication 312 may retransmitted as a 6 GHz communication 322. When a 6 GHz communication is less crowded compared to a 5 GHz communication, the 6 GHz communication may be used as the last link to relay the traffic to the STA 340.

The STA 340 may be operable to communicate to the first access point 310 using one or more of a 2.4 GHz frequency range, a 5 GHz frequency range, or a 6 GHz frequency range. The second AP 320 may receive, at the second AP 320 from the STA 340, a third wireless signal at a third frequency. The second AP 320 may convert, at the second AP 320, the third wireless signal at the third frequency to a fourth wireless signal at a fourth frequency. The fourth frequency may be lower than the third frequency. The third frequency may be in a 6 GHz frequency range and the fourth frequency may be in a 5 GHz frequency range.

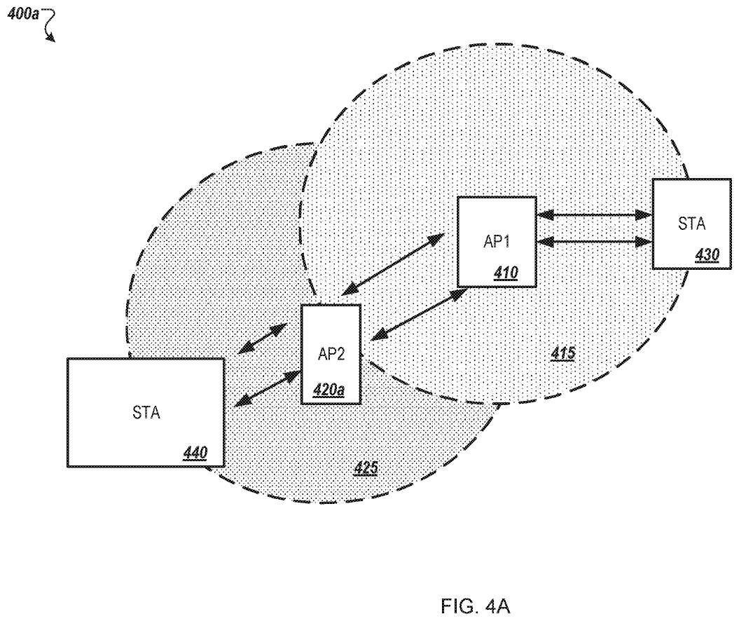

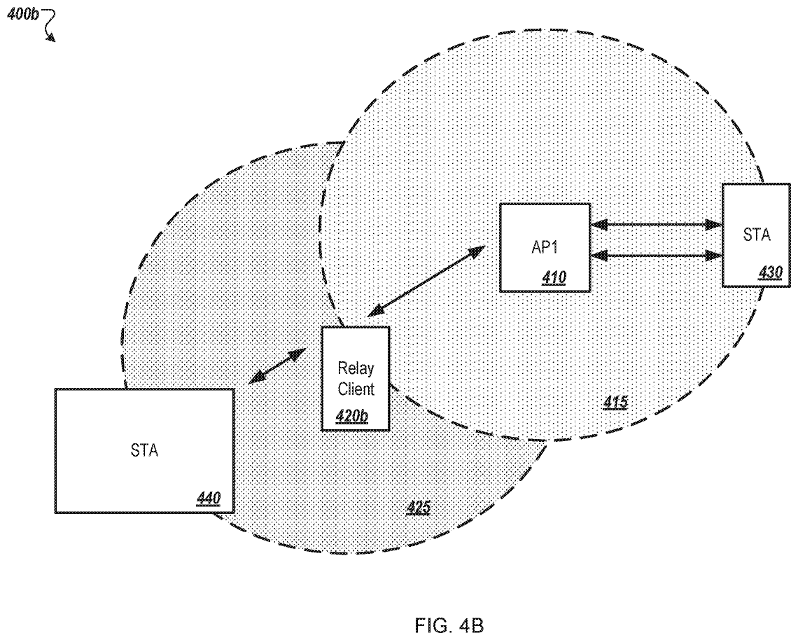

As illustrated in FIG. 4A, a coverage map 400a shows that a first AP 410 may communicate with a STA 440 via a second AP 420a without using a 2.4 GHz frequency range. The first access point 410 may receive a signal from a STA 430. The first access point may transmit a signal (e.g., using a 5 GHz frequency range), to a second access point 420a. The second access point 420a may transmit a signal (e.g., using a 6 GHZ frequency range) to a STA 440. The first access point 410 may have a coverage map 415 to show the communication range for the first access point 410 when a 5 GHZ frequency range is used. The second access point 420a may have a coverage map 425 to show the communication range for the second access point 420a when a 6 GHz frequency range is used.

A transmission opportunity may be used by any of the APs disclosed herein and in any figure. In one example, the processing device at the second access point 420a may be operable to reserve, at the second AP 420a, a first communication link used to receive the first wireless signal at the first frequency. The processing device may be operable to reserve, at the second AP 420a, a second communication link used to send the second wireless signal at the second frequency. One or more of the first communication link or the second communication link may be reserved using a multi-user request-to-send (MU-RTS) transmission opportunity (TxOP) sharing (MU-RTS TXS) trigger frame.

The MU-RTS TXS trigger frame may have a transmission opportunity sharing mode subfield value equal to 2.A MU-RTS TXS Trigger frame with TXOP Sharing Mode subfield value equal to 2 may be used to reserve the 6 GHz communication link for the duration of the 5 GHz transaction. The AP1 410 may win contention on 5 GHz and AP2 420a on 6 GHz to reserve the TXOP slot. A control message may be sent by AP1 410 to indicate to AP2 420a that AP2 420a may start the relay of the communication received from AP1 410.

Alternatively or in addition, the first wireless signal may up-convert without decoding a packet of the first wireless signal. To save power and delays, the 5 GHz packet received may not be decoded but may be up-converted to 6 GHz. Alternatively or in addition, the 6 GHz packet may be down-converted to 5 GHz.

The wireless signal received at AP2 420a from AP1 410 may be amplified. The processing device at AP2 420a may be operable to amplify the first wireless signal to compensate for attenuation across distance.

A Wi-Fi client close to the periphery of the communication range of an access point may be used to relay a payload to a destination client (e.g., a STA). As illustrated in FIG. 4B, a relay client 420b may be used alternatively or in addition to the second access point 420a. The relay client may include a processing device. The processing device may be operable to receive, at a relay client 420b from an AP1 410, a first wireless signal at a first frequency. The processing device may be operable to convert, at the relay client 420b, the first wireless signal at the first frequency to a second wireless signal at a second frequency. The second frequency may be higher than the first frequency. The processing device may be operable to send, from the relay client 420b for transmission to a destination client 440, the second wireless signal at the second frequency. The first frequency may be in a 5 GHz frequency range and the second frequency may be in a 6 GHz frequency range. The first access point 410 may be operable to transmit a signal 412 to the relay client 420b. The relay client may be operable to transmit a signal 422 to the destination client 440.

The relay client may be operable to forward a frame received from the AP1 410 for transmission to a destination client 440. The AP1 410 may not be within a direct communication range of the destination client 440 (e.g., using a 5 GHz frequency range or a 6 GHz frequency range). The relay client may be operable to be selected (e.g., by AP1 410) based on one or more of a signal strength or a network congestion.

In some examples, the relay client 420b may receive lower latency services compared to non-relay clients to incentivize relay clients to relay messages between access points and destination clients.

In some examples, the messages ending at the destination client may be packaged in the same MAC protocol data unit (MPDU). Data intended for multiple STAs may be directly aggregated into a single aggregated frame like MPDU or aggregate MAC Protocol Data Unit (AMPDU).

In some embodiments, further signal analysis may be used to determine any signal degradation or impairment. For example, Error Vector Magnitude of the signal may be performed to quantify the combination of all signal impairments on the signal. The received signal may be amplified and equalized by AP2 420a to compensate for attenuation across distance. This process may also amplify noise. Optimal modulation and coding scheme (MCS) may be determined and selected so that the amplified noise may not affect the decoding of the packet.

In other embodiments, sounding may be used to evaluate the environment for wireless communication. A Neighbor Discovery Protocol (NDP) sequence may be performed on 5 GHz communication link separately and a 6 GHz communication link. Each communication link may be performed autonomously at the link level and may not be relayed to the other AP. Responsive to any detected or calculated degradation or impairments, or environmental characteristic, any compensation, correction, remediation, etc. may be performed.

Modifications, additions, or omissions may be made to the FIGS. 2, 3, 4A, and 4B without departing from the scope of the present disclosure. For example, the designations of different elements in the manner described is meant to help explain concepts described herein and is not limiting. Further, FIGS. 2, 3, 4A, and 4B may include any number of other elements or may be implemented within other systems or contexts than those described. For example, any of the components of FIGS. 2, 3, 4A, and 4B may be divided into additional or combined into fewer components. Further, any of the components of FIGS. 2, 3, 4A, and 4B may be used interchangeably with similarly named items in other figures. For example, the APs STAs, coverage maps, frequency ranges, and operations of FIGS. 2, 3, 4A, and 4B may be used interchangeably.

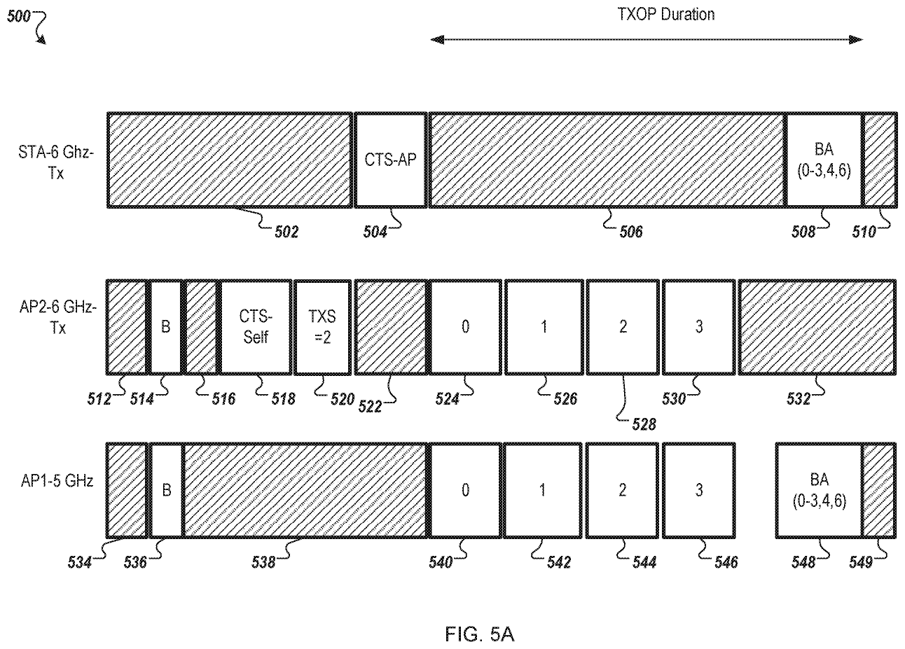

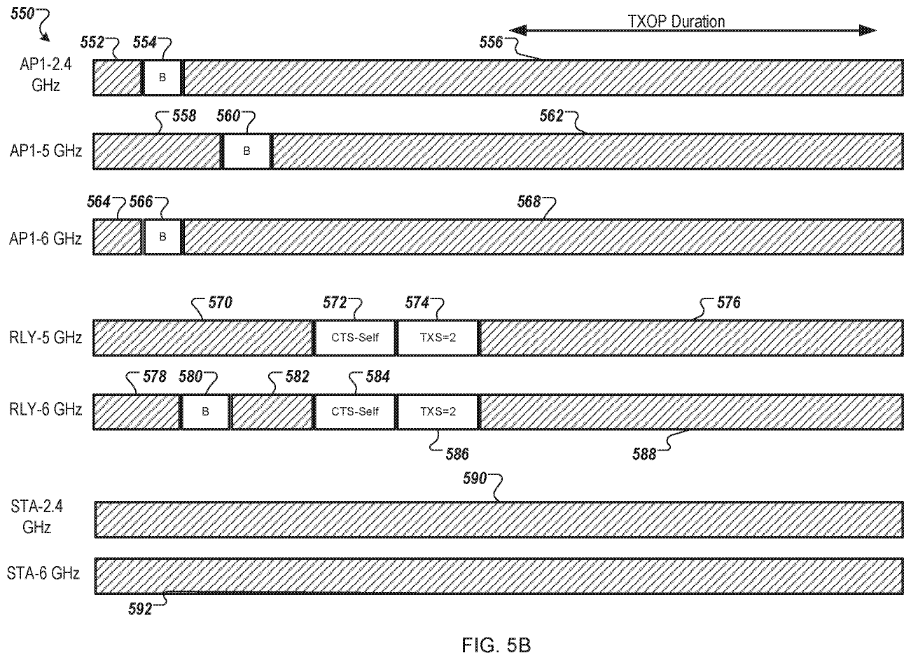

As illustrated in FIGS. 5A and 5B, an MU-RTS TXS Trigger frame with a particular header value, subfield value, or similar flag or trigger may be used to reserve the 6 GHz communication link for the duration of the 5 GHz transaction. For example, an MU-RTS TXS Trigger frame with TXOP Sharing Mode subfield value equal to 2 may be used to reserve the 6 GHz communication link for the duration of the 5 GHz transaction. The 5 GHz packet received may not be decoded but may be up-converted to 6 GHz. Alternatively or in addition, the 6 GHZ signal may be down-converted to 5G helping to save power and improve latency.

As illustrated in FIG. 5A, a diagram 500 shows that AP1 may be operable to communicate using a 5 GHz frequency range. AP1 may transmit a beacon frame 536. AP1 may transmit packet0 540, packet1 542, packet2 544, packet3 546, and BA548.

AP2 may be operable to communicate using a 6 GHz frequency range. AP2 may transmit a beacon frame 514, a packet0 524, a packet1 526, a packet2 528, and a packet3 530. AP2 may be configured to transmit a clear-to-send (CTS) to self 518 and may transmit an MU-RTS Trigger frame with TXOP sharing mode subfield value set to 2 (e.g., TXS=2 520).

STA may be operable to communicate a clear-to-send signal to an access point (e.g., AP1 or AP2) as shown by CTS-AP 504. The STA may be operable to transmit a BA 508.

AP1, AP2, and STA may have various time periods during which packets are not exchanged, e.g., during time periods 502, 506, 510, 512, 516, 522, 532, 534, 538, and 549.

As illustrated in FIG. 5B, a diagram 550 shows that AP1 may be operable to communicate using a 2.4 GHZ frequency range, a 5 GHz frequency range, or a 6 GHz frequency range. A relay client may be operable to communicate using one or more of a 5 GHZ frequency range or a 6 GHZ frequency range. A STA may be operable to communicate using one or more of a 2.4 GHz frequency range or a 6 GHz frequency range.

AP1 may be operable to transmit a beacon frame 554 using a 2.4 GHz frequency range, a beacon frame 560 using a 5 GHz frequency range, or a beacon frame 566 using a 6 GHz frequency range. AP1 may not transmit during time periods 552, 556, 558, 562, 564, 568 on selected frequency ranges.

The relay client may be operable to transmit a beacon frame 580 using a 6 GHz frequency range. The relay client may be operable to transmit a CTS-Self (e.g., CTS-Self 572 using a 5 GHz frequency range or CTS-Self 584 using a 6 GHz frequency range). The relay client may be operable to transmit a TXS-2 using a 5 GHz frequency range (e.g., TX=2 574) or a 6 GHz frequency range (e.g., TX=2 586). The relay client may not transmit during selected time periods (e.g., during time periods 570, 576, 578, 582, and 588). The STA may not transmit during selected time periods (e.g., time period 590 and time period 592).

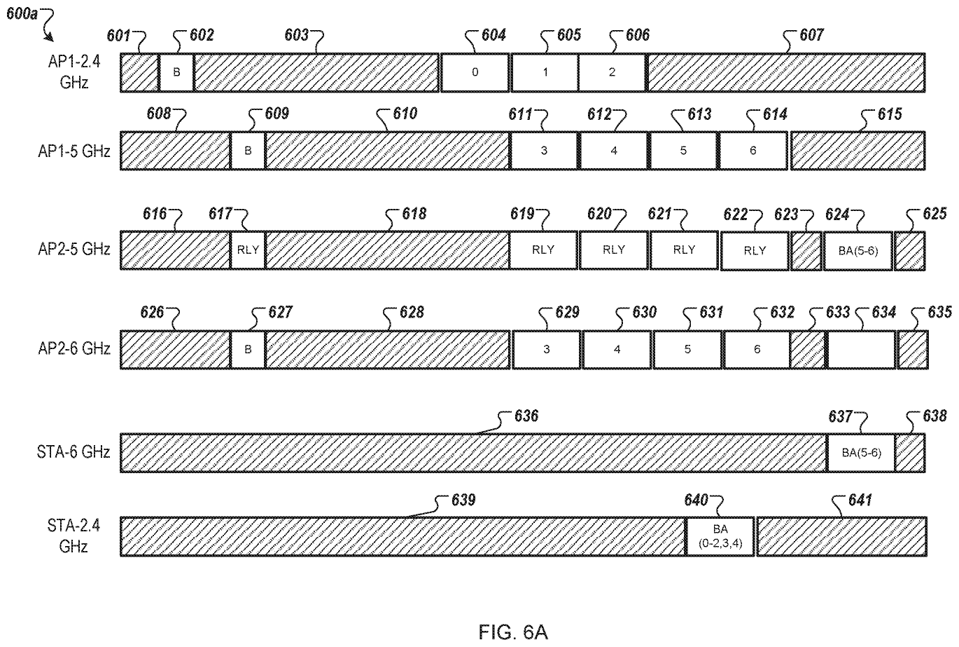

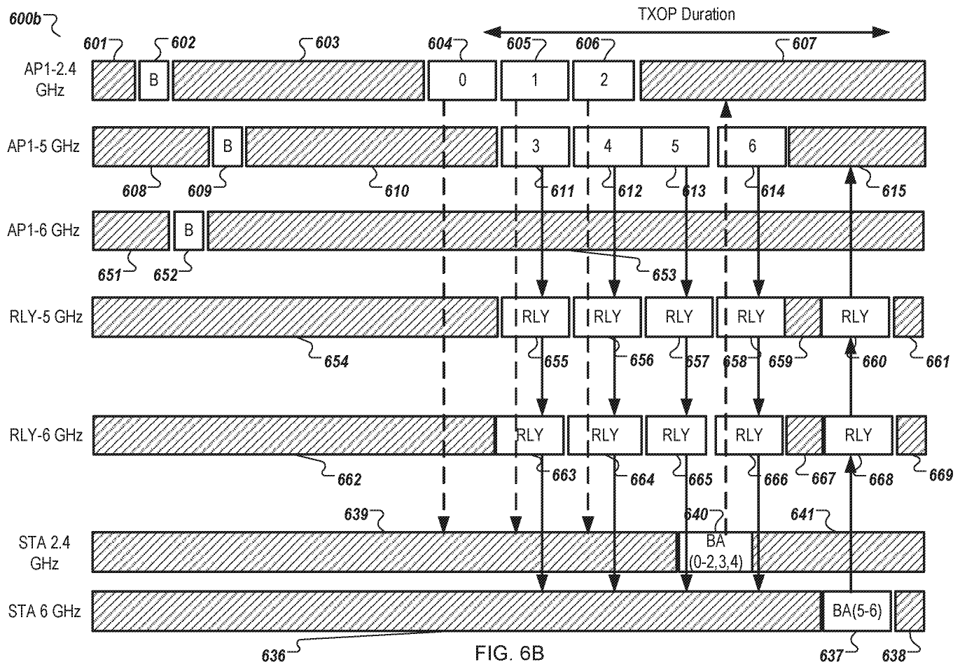

As illustrated in FIGS. 6A and 6B, diagrams 600a and 600b show that a first access point may be operable to communicate with a STA via a second access point. The first access point may transmit a beacon frame 602 and various packets (e.g., packet0 604, packet1 605, packet2 606) using a 2.4 GHz frequency range. The first access point may transmit a beacon 509 and various packets (e.g., packet3 611, packet4 612, packet5 613, and packet6 614) using a 5 GHz frequency range. The first access point may not transmit during selected time periods (e.g., 601, 603, 607, 608, 610, and 615).

The second access point may be operable to relay various packets (e.g., 617, 619, 620, 621, 622) and send a BA 624 to AP1. The second access point may be operable to convert selected packets from a 5 GHz frequency range to a 6 GHz frequency range and transmit the packets to a STA using a 6 GHz frequency range. For example, the second access point may: transmit the beacon frame 627 as received from the first access point; transmit packet3 629 as received from the first access point; transmit packet4 630 as received from the first access point; transmit packet5 631 as received from the first access point; transmit packet6 632 as received from the first access point. The second access point may not communicate during selected time periods (e.g., 616, 618, 623, 625, 626, 628, 633, 635).

STA may be operable to send a BA 640 using a 2.4 GHz frequency range. STA may be operable to send a BA 637 using a 6 GHz frequency range. The STA may not communicate during selected time periods (e.g., 636, 638, 639, and 641).

As illustrated in FIG. 6B, the diagram 600b shows that the first access point may be operable to communicate using a 6 GHz frequency range. The first access point may transmit a beacon frame 652. The first access point may not transmit in other time periods using the 6 GHz frequency range (e.g., during time periods 651 and 653).

The relay client may be operable to relay the signals received from the first access point using a 5 GHz frequency range or a 6 GHz frequency range. The relay client may relay (or forward) packet3 611 to the STA as shown using relay (RLY) 655 and RLY 663. The relay client may relay (or forward) packet4 612 to the STA as shown using RLY 656 and RLY 664. The relay client may relay (or forward) packet5 613 to the STA as shown using RLY 657 and RLY 665. The relay client may relay (or forward) packet6 614 to the STA as shown using RLY 658 and RLY 666. The STA may send a BA 637 to first access point using relay 668 and relay 660. The relay client may not transmit in other time periods (e.g., during time periods 654, 659, 661, 662, 667, and 669).

Packet0 604, packet1 605, and packet2 606 may be transmitted to the STA using the 2.4 GHz frequency range. The STA may transmit a BA 640 to the first access point using a 2.4 GHz frequency range. The STA may not transmit in other time periods (e.g., during time periods 639 and 641).

The AP1 may win contention on 5 GHz and AP2 on 6 GHz to reserve the TXOP slot. Alternatively or in addition, AP1 may be operable to receive, at AP1 from a different AP, a control message operable to indicate a relay start. A control message may be sent by AP1 to indicate to AP2 that it can start the relay of what is received from AP1.

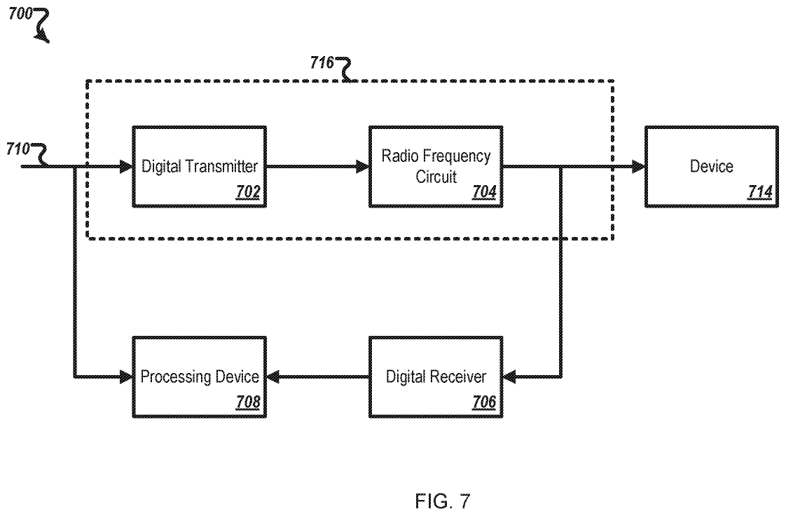

FIG. 7 illustrates a block diagram of an example communication system 700 configured for AP interference reduction, in accordance with at least one example described in the present disclosure. The communication system 700 may include a digital transmitter 702, a radio frequency circuit 704, a device 714, a digital receiver 706, and a processing device 708. The digital transmitter 702 and the processing device may be configured to receive a baseband signal via connection 710. A transceiver 716 may include the digital transmitter 702 and the radio frequency circuit 704.

In some examples, the communication system 700 may include a system of devices that may be configured to communicate with one another via a wired or wireline connection. For example, a wired connection in the communication system 700 may include one or more Ethernet cables, one or more fiber-optic cables, and/or other similar wired communication mediums. Alternatively, or additionally, the communication system 700 may include a system of devices that may be configured to communicate via one or more wireless connections. For example, the communication system 700 may include one or more devices configured to transmit and/or receive radio waves, microwaves, ultrasonic waves, optical waves, electromagnetic induction, and/or similar wireless communications. Alternatively, or additionally, the communication system 700 may include combinations of wireless and/or wired connections. In these and other examples, the communication system 700 may include one or more devices that may be configured to obtain a baseband signal, perform one or more operations to the baseband signal to generate a modified baseband signal, and transmit the modified baseband signal, such as to one or more loads.

In some examples, the communication system 700 may include one or more communication channels that may communicatively couple systems and/or devices included in the communication system 700. For example, the transceiver 716 may be communicatively coupled to the device 714.

In some examples, the transceiver 716 may be configured to obtain a baseband signal. For example, as described herein, the transceiver 716 may be configured to generate a baseband signal and/or receive a baseband signal from another device. In some examples, the transceiver 716 may be configured to transmit the baseband signal. For example, upon obtaining the baseband signal, the transceiver 716 may be configured to transmit the baseband signal to a separate device, such as the device 714. Alternatively, or additionally, the transceiver 716 may be configured to modify, condition, and/or transform the baseband signal in advance of transmitting the baseband signal. For example, the transceiver 716 may include a quadrature up-converter and/or a digital to analog converter (DAC) that may be configured to modify the baseband signal. Alternatively, or additionally, the transceiver 716 may include a direct radio frequency (RF) sampling converter that may be configured to modify the baseband signal.

In some examples, the digital transmitter 702 may be configured to obtain a baseband signal via connection 710. In some examples, the digital transmitter 702 may be configured to up-convert the baseband signal. For example, the digital transmitter 702 may include a quadrature up-converter to apply to the baseband signal. In some examples, the digital transmitter 702 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 702.

In some examples, the transceiver 716 may include one or more subcomponents that may be used in preparing the baseband signal and/or transmitting the baseband signal. For example, the transceiver 716 may include an RF front end (e.g., in a wireless environment) which may include a power amplifier (PA), a digital transmitter (e.g., 702), a digital front end, an institute of electrical and electronics engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 704) of the transceiver 716 may be synchronized with the resource controller via the S-plane device, which may contribute to high-accuracy timing with respect to a reference clock.

In some examples, the transceiver 716 may be configured to obtain the baseband signal for transmission. For example, the transceiver 716 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 716 may be configured to generate a baseband signal for transmission. In these and other examples, the transceiver 716 may be configured to transmit the baseband signal to another device, such as the device 714.

In some examples, the device 714 may be configured to receive a transmission from the transceiver 716. For example, the transceiver 716 may be configured to transmit a baseband signal to the device 714.

In some examples, the radio frequency circuit 704 may be configured to transmit the digital signal received from the digital transmitter 702. In some examples, the radio frequency circuit 704 may be configured to transmit the digital signal to the device 714 and/or the digital receiver 706. In some examples, the digital receiver 706 may be configured to receive a digital signal from the RF circuit and/or send a digital signal to the processing device 708.

In some examples, the processing device 708 may be a standalone device or system, as illustrated. Alternatively, or additionally, the processing device 708 may be a component of another device and/or system. For example, in some examples, the processing device 708 may be included in the transceiver 716. In instances in which the processing device 708 is a standalone device or system, the processing device 708 may be configured to communicate with additional devices and/or systems remote from the processing device 708, such as the transceiver 716 and/or the device 714. For example, the processing device 708 may be configured to send and/or receive transmissions from the transceiver 716 and/or the device 714. In some examples, the processing device 708 may be combined with other elements of the communication system 700.

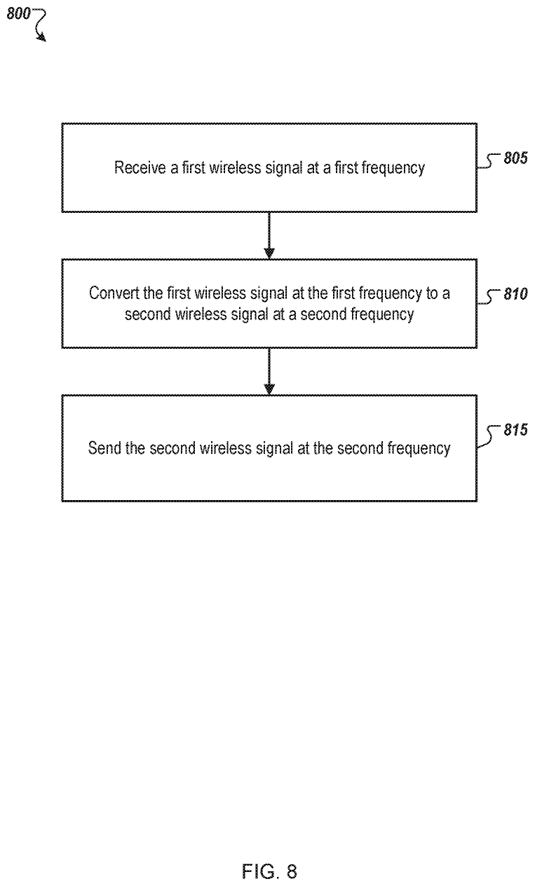

FIG. 8 illustrates a process flow of an example method 800 of LLMR, in accordance with at least one example described in the present disclosure. The method 800 may be arranged in accordance with at least one example described in the present disclosure.

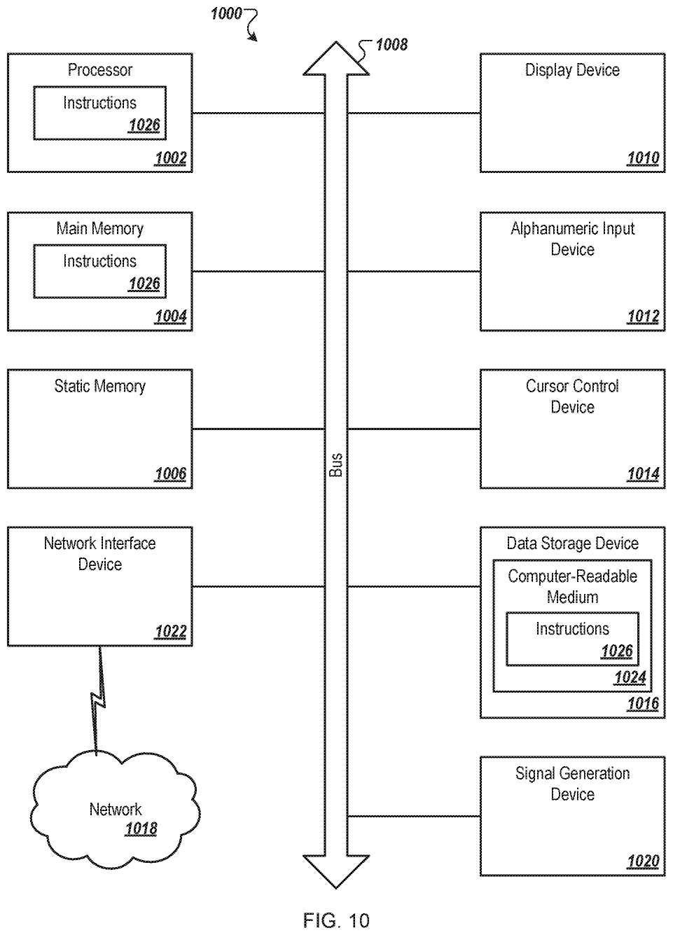

The method 800 may be performed by processing logic that may include hardware (circuitry, dedicated logic, etc.), software (such as is run on a computer system or a dedicated machine), or a combination of both, which processing logic may be included in the processing device (e.g., processor 1002) of FIG. 10, the communication system 700 of FIG. 7, or another device, combination of devices, or systems.

The method 800 may begin at block 805 where the processing logic may receive, at the AP from a different AP, a first wireless signal at a first frequency.

At block 810, the processing logic may convert, at the AP, the first wireless signal at the first frequency to a second wireless signal at a second frequency, wherein the second frequency is higher than the first frequency.

At block 815, the processing logic may send, from the AP for transmission to a station (STA), the second wireless signal at the second frequency.

Modifications, additions, or omissions may be made to the method 800 without departing from the scope of the present disclosure. For example, in some examples, the method 800 may include any number of other components that may not be explicitly illustrated or described.

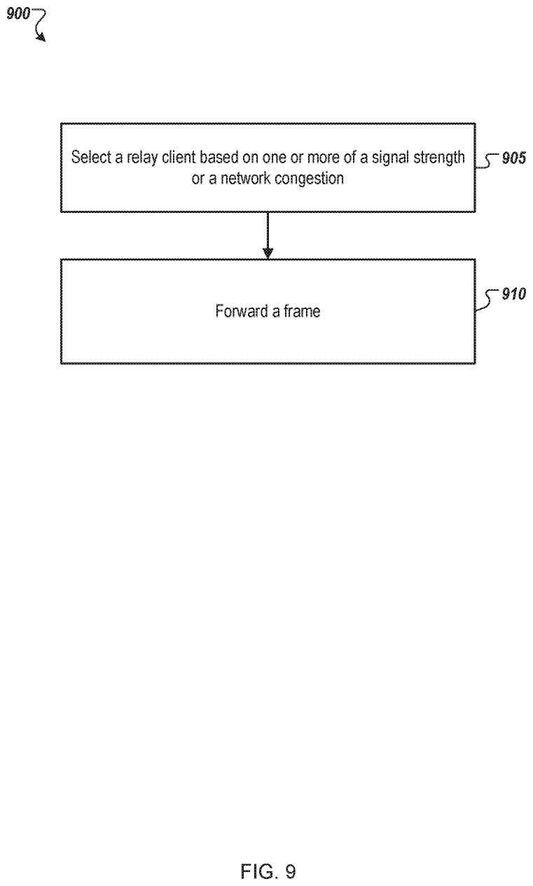

FIG. 9 illustrates a process flow of an example method 900 that may be used for LLMR, in accordance with at least one example described in the present disclosure. The method 900 may be arranged in accordance with at least one example described in the present disclosure.

The method 900 may be performed by processing logic that may include hardware (circuitry, dedicated logic, etc.), software (such as is run on a computer system or a dedicated machine), or a combination of both, which processing logic may be included in the processing device (e.g., processor 1002) of FIG. 10, the communication system 700 of FIG. 7, or another device, combination of devices, or systems.

The method 900 may begin at block 905 where the processing logic may select, at an access point, a relay client based on one or more of a signal strength or a network congestion.

At block 910, the processing logic may forward, from the access point for transmission to a station (STA) using the relay client, a frame, wherein the access point is not within a direct communication range of the STA. The frame may be a single aggregated frame (e.g., a MAC protocol data unit (MPDU) or an aggregated MAC protocol data unit (AMPDU)).

The processing logic may further select the relay client to reduce latency and enhance throughput. The processing logic may further select the relay client based on quality of service (Qos). The processing logic may further reduce energy usage compared to a baseline energy usage when the relay is a battery-operated relay. The processing logic may further send, from the access point to the relay client for transmission to the STA, the frame using a signal in a 5G frequency range. The processing logic may further send, from the relay client to the STA, the frame using a signal in a 6G frequency range.

For the MAC relay, rather than using a neighboring AP to relay the data, the STAs close to the periphery of the AP reach could be used to relay the payload to the final STA. These devices relaying the messages could be incentivized, such as by providing lower latency services for relay devices. The messages ending at the relay and end devices could be packaged in the same MPDU. Current Wi-Fi standards have no direct aggregation mechanism that bundles data intended for multiple STAs into a single aggregated frame like MPDU or AMPDU, the present disclosure may provide such functionality.

Modifications, additions, or omissions may be made to the method 1200 without departing from the scope of the present disclosure. For example, in some examples, the method 1200 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 10 illustrates a diagrammatic representation of a machine in the example form of a computing device 1000 within which a set of instructions, for causing the machine to perform any one or more of the methods discussed herein, may be executed. The computing system may be configured to implement or direct one or more operations associated with AP interference reduction. The computing device 1000 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1000 includes a processing device (e.g., a processor 1002), a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1016, which communicate via a bus 1008.

Processing device (e.g., a processor 1002) represents one or more general-purpose processing devices such as a microprocessor, central processing unit, or the like. More particularly, the processing device (e.g., a processor 1002) may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device (e.g., a processor 1002) may also include one or more special-purpose processing devices such as an application specific integrated circuit (ASIC), a field programmable gate array (FPGA), a digital signal processor (DSP), network processor, or the like. The processing device (e.g., a processor 1002) may be configured to execute instructions 1026 for performing the operations and steps discussed herein.

The computing device 1000 may further include a network interface device 1022 which may communicate with a network 1018. The computing device 1000 also may include a display device 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1020 (e.g., a speaker). In at least one example, the display device 1010, the alphanumeric input device 1012, and the cursor control device 1014 may be combined into a single component or device (e.g., an LCD touch screen).

The data storage device 1016 may include a computer-readable storage medium 1024 on which is stored one or more sets of instructions 1026 embodying any one or more of the methods or functions described herein. The instructions 1026 may also reside, completely or at least partially, within the main memory 1004 and/or within the processing device (e.g., a processor 1002) during execution thereof by the computing device 1000, the main memory 1004 and the processing device (e.g., a processor 1002) also constituting computer-readable media. The instructions may further be transmitted or received over a network 1018 via the network interface device 1022.

While the computer-readable storage medium 1024 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
receive, at the AP from a different AP, a first wireless signal at a first frequency;
convert, at the AP, the first wireless signal at the first frequency to a second wireless signal at a second frequency, wherein the second frequency is higher than the first frequency; and
send, from the AP for transmission to a station (STA), the second wireless signal at the second frequency.

2. The access point of claim 1, wherein the processing device is further operable to:
reserve, at the AP, a first communication link used to receive the first wireless signal at the first frequency; and
reserve, at the AP, a second communication link used to send the second wireless signal at the second frequency,
wherein one or more of the first communication link or the second communication link are reserved using a multi-user request-to-send (MU-RTS) transmission opportunity (TxOP) sharing (MU-RTS TXS) trigger frame.

3. The access point of claim 2, wherein the MU-RTS TXS trigger frame has a transmission opportunity sharing mode subfield value equal to 2.

4. The access point of claim 1, wherein the first wireless signal is up-converted without decoding a packet of the first wireless signal.

5. The access point of claim 1, wherein the processing device is further operable to:
amplify, at the access point, the first wireless signal to compensate for attenuation across distance.

6. The access point of claim 1, wherein the processing device is further operable to:
receive, at the AP from the different AP, a control message operable to indicate a relay start.

7. The access point of claim 1, wherein the processing device is further operable to:
receive, at the AP from the STA, a third wireless signal at a third frequency,
convert, at the AP, the third wireless signal at the third frequency to a fourth wireless signal at a fourth frequency, wherein the fourth frequency is lower than the third frequency.

8. The access point of claim 7, wherein the third frequency is in a 6 GHz frequency range and the fourth frequency is in a 5 GHz frequency range.

9. The access point of claim 1, wherein the first frequency is in a 5 GHz frequency range and the second frequency is in a 6 GHz frequency range.

10. The access point of claim 1, wherein different AP is not within a direct communication range of the STA.

11. A method for wireless local area network (WLAN) medium access control (MAC) relay, comprising:
selecting, at an access point, a relay client based on one or more of a signal strength or a network congestion; and
forwarding, from the access point for transmission to a station (STA) using the relay client, a frame, wherein the access point is not within a direct communication range of the STA.

12. The method of claim 11, wherein the frame is a single aggregated frame.

13. The method of claim 11, wherein selecting the relay client is based on quality of service (QOS).

14. The method of claim 11, further comprising:
reducing energy usage compared to a baseline energy usage when the relay is a battery-operated relay.

15. The method of claim 11, further comprising:
sending, from the access point to the relay client for transmission to the STA, the frame using a signal in a 5 GHz frequency range.

16. The method of claim 11, further comprising:
sending, from the relay client to the STA, the frame using a signal in a 6 GHz frequency range.

17. A relay client, comprising:
a processing device operable to:
receive, at a relay client from an AP, a first wireless signal at a first frequency,
convert, at the relay client, the first wireless signal at the first frequency to a second wireless signal at a second frequency, wherein the second frequency is higher than the first frequency; and
send, from the relay client for transmission to a station (STA), the second wireless signal at the second frequency.

18. The relay client of claim 17, wherein the first frequency is in a 5 GHz frequency range and the second frequency is in a 6 GHz frequency range.

19. The relay client of claim 17, wherein the processing device is further operable to forward, at the relay client, a frame received from the AP for transmission to a station (STA), wherein the AP is not within a direct communication range of the STA.

20. The relay client of claim 19, wherein the frame is a single aggregated frame.
